(19) United States
(12) Patent Application Publication
(10) Pub. No.: US 2014/0038580 A1
(43) Pub. Date: Feb. 6, 2014

(54) METHOD FOR COMMUNICATION OF BASE STATION AND TERMINAL

(71) Applicant: Electronics and Telecommunications Research Institute, Daejeon (KR)

(72) Inventors: Won-Ik KIM, Daejeon (KR); Eunkyung Kim, Daejeon (KR); Sung Kyung Kim, Daejeon (KR); Sung Cheol Chang, Daejeon (KR); Jae Sun Cha, Daejeon (KR); Mi Young Yun, Daejeon (KR); Hyun Lee, Daejeon (KR); Chul Sik Yoon, Seoul (KR); Kwang Jae Lim, Daejeon (KR)

(73) Assignee: Electronics and Telecommunications Research Institute, Daejeon (KR)

(21) Appl. No.: 14/050,989

(22) Filed: Oct. 10, 2013

Related U.S. Application Data
(62) Division of application No. 13/546,543, filed on Jul. 11, 2012.

(30) Foreign Application Priority Data
Jul. 11, 2011 (KR) 10-2011-0068543
Jul. 11, 2011 (KR) 10-2011-0068544
Mar. 6, 2012 (KR) 10-2012-0022938
Jul. 11, 2012 (KR) 10-2012-0075358
Jul. 11, 2012 (KR) 10-2012-0075359

(51) Int. Cl. H04W 24/02

(52) U.S. Cl. CPC H04W 24/02
USPC 455/418

(57) ABSTRACT

A method of performing communication of a terminal includes the terminal transmitting state information thereof to a base station, and the terminal receiving a mode change request from the base station when the terminal is selected by the base station.

### CROSS-REFERENCE TO RELATED APPLICATION

This application is a divisional application of co-pending application Ser. No. 13/546,543, and claims priority to and the benefit of Korean Patent Application Nos. 10-2011-0068543, 10-2011-0068544, 10-2012-0022938, 10-2012-0075358, and 10-2012-0075359 filed in the Korean Intellectual Property Office on Jul. 11, 2011, Jul. 11, 2011, Mar. 6, 2012, Jul. 11, 2012, and Jul. 11, 2012, respectively, the entire contents of which are incorporated herein by reference.

### BACKGROUND OF THE INVENTION

(a) Field of the Invention

The present invention relates to a method of performing communication of a base station and a terminal.

(b) Description of the Related Art

When a disaster or a calamity occurs, an important society infrastructure may be broken or damaged. In the society infrastructure, various communication facilities such as a wireless phone, a wired phone, and an Internet network are important, and when such a communication facility is broken or damaged in a disaster or calamity occurrence situation, the society congestion level increases and it may be difficult to recover the society. Therefore, in such a case, it is important to quickly recover a communication facility or to provide a means to replace a communication facility.

That is, when a mobile communication infrastructure no longer operates a network, or by a multi-mode terminal itself or a request of a super-ordinate base station as an auxiliary alternative means for a special mission, the multi-mode terminal can construct and operate a temporary network through function conversion to a base station or a relay station.

In this case, when the super-ordinate base station requests a function of a base station or a relay station to a sub-ordinate multi-mode terminal, it is necessary to define a method and procedure for selecting an optimal multi-mode terminal. When a multi-function terminal that is selected to perform a function of a base station or a relay station is positioned at an area that may cause serious electronic wave interference or at an area that does not cover a plurality of terminals, or when an operation state of the multi-mode terminal is not good, even if a temporary network is constructed, a connection to a plurality of terminals is impossible or a network configuration is frequently changed and thus performance of the temporary network is very low.

Further, for when a base station of a communication facility is damaged, a discussion about a method in which a multi-mode terminal performs a base station function as well as direct communication as an alternative communication method has been actively performed. Here, it is necessary to define a method of a start condition in which a multi-mode terminal performs a base station function. That is, in a disaster or calamity environment, when a base station is damaged without notice, if an adjacent plurality of multi-mode terminals simultaneously perform a base station function, electronic wave interference may occur. Particularly, as a distance between multi-mode terminals is small, electronic wave interference may be more serious.

Further, even if the multi-mode terminal starts a base station function without electronic wave interference, when a terminal state such as a battery residual quantity is not good, the multi-mode terminal should transfer a base station function to another multi-mode terminal and thus a network load may occur.

### SUMMARY OF THE INVENTION

The present invention has been made in an effort to provide a method of performing communication of a base station and a terminal having advantages of forming an optimal temporary network topology by a multi-mode terminal.

The present invention has been made in an effort to further provide a method of performing communication of a base station and a terminal having advantages of selecting a multi-mode terminal that can avoid mutual electronic wave interference and that can perform an optimal base station function when multi-mode terminals perform a base station function.

An exemplary embodiment of the present invention provides a method of performing communication of a terminal, the method including: the terminal transmitting state information thereof to a base station; and the terminal receiving a mode change request from the base station when the terminal is selected by the base station.

The method may further include operating as a base station or a relay station, after the mode change request is received.

The state information may include a battery level.

The transmitting of state information thereof may include transmitting the battery level through an AMS battery level report header or an MM-STAT-REP message.

The method may further include receiving a report request about the state information from the base station.

The transmitting of state information thereof may be performed after receiving the report request.

The terminal may be a multi-mode terminal that can operate as a base station or a relay station.

Another embodiment of the present invention provides a method of performing communication of a base station, the method including: receiving state information from each of a plurality of terminals; selecting a target terminal from the plurality of terminals based on the state information; and transmitting a mode change request to the target terminal.

The mode change request may include a request for enabling the terminal to operate as a base station or a relay station.

The state information may include a battery level.

The receiving of state information may include receiving the battery level through an AMS battery level report header or an MM-STAT-REP message.

Yet another embodiment of the present invention provides a method of performing communication of a terminal, the method including: the terminal starting a mode change when a base station is damaged, if a random backoff timer has expired; and the terminal operating as a base station after the mode change is complete.

A random backoff delay time that is calculated by the random backoff timer may be determined according to state information of the terminal.

The state information may include a battery level of the terminal.

The terminal may be a multi-mode terminal that can operate as a base station or a relay station.

Yet another embodiment of the present invention provides a method of performing communication of a terminal, the method including: the terminal calculating a value of a backoff timer; and the terminal stopping a mode change when the terminal receives an electronic wave signal before the backoff timer has expired.

The terminal may be a multi-mode terminal that can operate as a base station or a relay station.

The calculating of a value may include calculating a value of the backoff timer based on state information of the terminal.

The state information may include a battery level of the terminal.

As a battery residual quantity of the terminal increases, a value of the backoff timer may decrease, and as a battery residual quantity of the terminal decreases, a value of the backoff timer may increase.

### BRIEF DESCRIPTION OF THE DRAWINGS

FIG. 1 is a flowchart illustrating a communication method according to an exemplary embodiment of the present invention.

FIG. 2 is a flowchart illustrating a communication method according to another exemplary embodiment of the present invention.

FIG. 3 is a flowchart illustrating a communication method according to another exemplary embodiment of the present invention.

FIG. 4 is a diagram illustrating an example of electronic wave interference that may occur in a communication system according to another exemplary embodiment of the present invention.

FIG. 5 is a flowchart illustrating a communication method according to another exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In the entire specification, a mobile station (MS) may indicate a terminal, a mobile terminal (MT), a subscriber station (SS), a portable subscriber station (PSS), an access terminal (AT), user equipment (UE), an advanced mobile station (AMS), and a high reliability mobile station (HR-MS), and may include an entire function or a partial function of the terminal, the MT, the SS, the PSS, the AT, the UE, the AMS, and the HR-MS.

Further, a base station 100 may indicate a node B, an evolved node B (eNode B), an access point (AP), a radio access station (RAS), a base transceiver station (BTS), a mobile multihop relay (MMR)-base station, an advanced base station (A-base station), a high reliability base station (HR-base station), a relay station (RS) that performs a base station function, an advanced relay station (ARS), or a high reliability relay station (HR-RS) that performs a base station function, and may include an entire function or a partial function of the node B, the eNode B, the AP, the RAS, the BTS, the MMR-base station, the A-base station, the HR-base station, the RS, the ARS, and the HR-RS.

Hereinafter, a method of performing communication of a base station and a terminal will be described in detail with reference to the drawings.

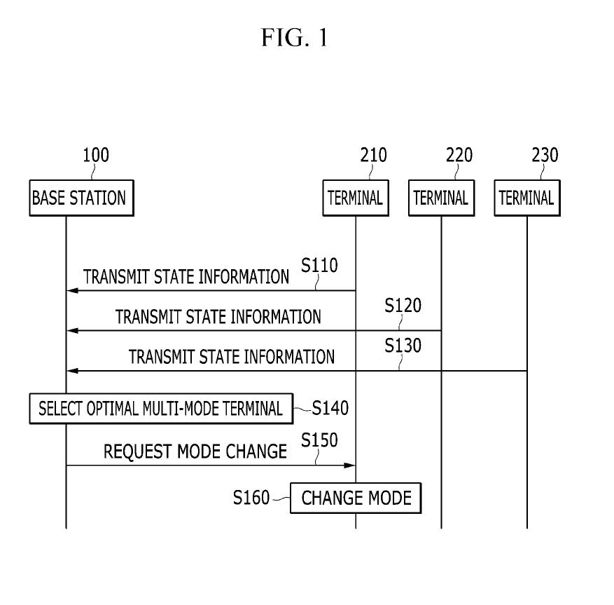

FIG. 1 is a flowchart illustrating a communication method according to an exemplary embodiment of the present invention.

Referring to FIG. 1, a plurality of terminals 210, 220, and 230 each transmit state information to a base station 100 (S110, S120, and S130). In this case, the terminals 210, 220, and 230 are multi-mode terminals that can perform a function of a base station or a relay station. Further, the base station 100 may be another multi-mode terminal that operates as a base station.

The state information that is transmitted by the terminals 210, 220, and 230 becomes an index for determining whether the terminals 210, 220, and 230 can most efficiently perform a function of a base station or a relay station. In this case, when the base station 100 operates normally, the base station 100 periodically receives basic state information from a plurality of terminals 210, 220, and 230, and this is referred to as a periodic method.

The state information that is transmitted by the terminals 210, 220, and 230 includes basic state information.

The basic state information includes electronic wave interference information from an adjacent base station or an adjacent relay station, electronic wave interference information from an adjacent multi-mode terminal, a battery level of corresponding terminals 210, 220, and 230, and information that is related to a state of the corresponding terminals 210, 220, and 230.

In order to transmit state information, the terminals 210, 220, and 230 generate a state report message including the state information. A portion of the state information may use various media access control (MAC) messages and a MAC signaling header that are defined in an existing communication system, and the remaining contents that are not defined are separately defined. In IEEE 802.16m and IEEE 802.16n, an existing defined state report message is exemplified as follows.

When state information is electronic wave interference information from an adjacent base station or relay station, the terminals 210, 220, and 230 perform a state report thereof through exchange of a scanning response (AAI-SCN-RSP) or scanning report (AAI-SCN-REP) message, which is a MAC control message, with the base station 100. Further, the terminals 210, 220, and 230 transmit an MM-STAT-REP message, which is a MAC control message, to a super-ordinate base station and perform a state report thereof.

When state information is a battery level of the terminals 210, 220, and 230, the terminals 210, 220, and 230 perform a state report thereof using an AMS battery level report header, which is a MAC signaling header. Further, the terminals 210, 220, and 230 perform a state report thereof using an uplink power status report header that can report an uplink power state of the terminals 210, 220, and 230.

In this case, detailed parameters of an AMS battery level report header and the MM-STAT-REP message are shown in Table 1 and Table 2, respectively. The AMS battery level report header and the MM-STAT-REP message commonly include an AMS battery status of a terminal representing whether a terminal is charging, an AMS battery level of the terminal representing an energy amount remaining in a battery of the terminal, and a max capacity of AMS battery representing a maximum capacitance of a battery that is mounted in the terminal.

TABLE 1
AMS Battery Level Report Header format

| | Size | |
|---|---|---|
| Syntax | (bits) | Notes |
| AMS Battery | — | — |
| Level | | |
| Report header ( ) | | |

{

| | | |
|---|---|---|
| FID | 4 | Flow Identifier. This field indicates MAC |
| | | signaling header. Set to 0010. |
| Type | 5 | MAC signaling header type = 0b00100 |
| Length | 3 | Indicates the length of the signaling header in |
| | | bytes. |
| AMS Battery | 1 | 0b0: The AMS is plugged into a power source. |
| Status | | 0b1: The AMS is not plugged into a power |
| | | source. |
| Battery Level | 1 | 0b0: Detailed battery level report is not |
| Indication | | included. |
| | | 0b1: Detailed battery level report is included. |
| If (Battery Level | | |
| Indication == 1) { | | |
| AMS Battery | 3 | 0b000: Battery level is >75% and ≦100% |
| Level | | 0b001: Battery level is >50% and ≦75% |
| | | 0b010: Battery level is >25% and ≦50% |
| | | 0b011: Battery level is >5% and ≦25% |
| | | 0b100: Battery level is below 5% |
| | | 0b101-0b111: Reserved |
| Max Capacity of | 4 | 0b0000: No support |
| AMS Battery | | 0b0001-0b1110: 1 Wh-31 Wh (round off to |
| | | the nearest whole number) |
| | | 0b1111: The maximum capacity of battery is |
| | | more than 32 Wh or the battery is charging. |
| Reserved | 3 | Shall be filled by 0 |
| } | | |
| else { | | |
| Reserved | 2 | Shall be filled by 0 |
| } | | |
| } | | |

TABLE 2

| | Size | |
|---|---|---|
| Syntax | bits) | Notes |
| MM-STAT-REP | — | — |
| message format ( ) { | | |
| Management Message | 8 | — |
| Type = [TBD] | | |
| MS Battery Status | 1 | 0b0: The HR-MS is plugged into a power |
| | | source. |
| | | 0b1: The HR-MS is not plugged into a |
| | | power source. |
| MS Battery Level | 3 | 0b000: Battery level is >75% and ≦100% |
| | | 0b001: Battery level is >50% and ≦75% |
| | | 0b010: Battery level is >25% and ≦50% |
| | | 0b011: Battery level is >5% and ≦25% |
| | | 0b100: Battery level is below 5% |
| | | 0b101-0b111: Reserved |
| Max Capacity of MS | 4 | 0b0000: No support |
| Battery | | 0b0001-0b1110: 1 Wh-31 Wh (round off |
| | | to the nearest whole number) |
| | | 0b1111: The maximum capacity of battery |
| | | is more than 32 Wh or the battery is |
| | | charging. |
| } | | |

Electronic wave interference information from an adjacent terminal and information that is related to a terminal state is defined as follows.

In an exemplary embodiment of the present invention, all such state information may be defined as a MAC control message (AAI-HRBS-REQ, AAI-HRRS-REQ, or MM-STAT-REP) or a MAC signaling header (HRMS multimode status report header, AMS battery level report header, and uplink power status report), and the MAC signaling header (HRMS multimode status report header) is exemplified.

The HRMS multimode status report header includes state information of a sub-ordinate multi-function terminal necessary when a super-ordinate base station selects an optimal multi-function terminal as well as the two information sets.

The base station 100 that acquires state information of the terminals 210, 220, and 230 through previously defined various MAC control messages, various MAC signaling headers, and a MAC control message or a MAC signaling header that is defined in an exemplary embodiment of the present invention selects an optimal multi-mode terminal 210 according to an optimal base station or relay station selection method that is defined in the base station 100 based on the state information (S140).

Thereafter, the base station 100 transmits the AAI-HRBS-CONFIG-CMD or AAI-HRRS-CONFIG-CMD message, which is a MAC control message, to the selected terminal 210 and requests the selected terminal 210 to operate in a base station or relay station mode (S150).

The terminal 210, having received the AAI-HRBS-CONFIG-CMD/AAI-HRRS-CONFIG-CMD message from the base station 100, changes a mode thereof to a base station or relay station mode, and is operated in the base station or relay station mode (S160).

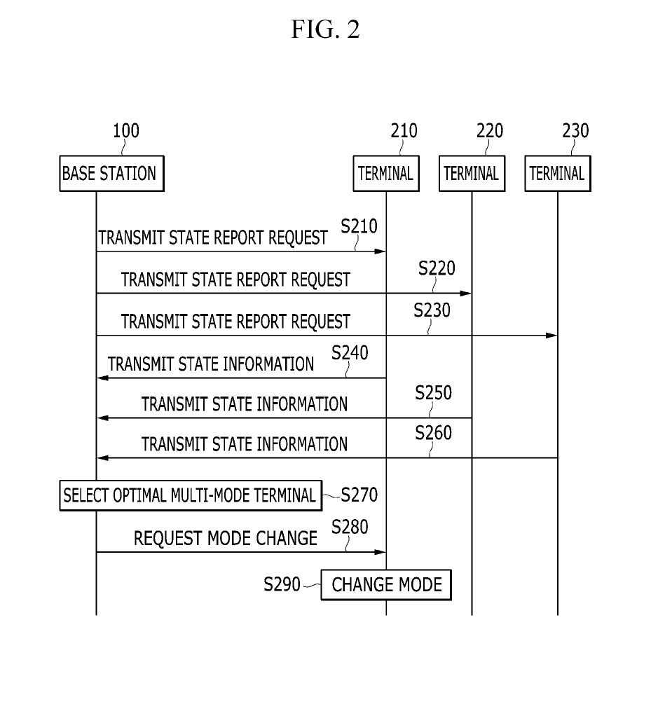

Hereinafter, a communication method according to another exemplary embodiment of the present invention will be described in detail with reference to FIG. 2.

FIG. 2 is a flowchart illustrating a communication method according to another exemplary embodiment of the present invention.

Referring to FIG. 2, when a case of selecting an optimal multi-mode terminal occurs, the base station 100 transmits a state report request to a plurality of terminals 210, 220, and 230 (S210, S220, and S230). That is, the base station 100 transmits a MAC control message (AAI-MM-ADV, AAI-HRBS-REQ, AAI-HRRS-REQ, or AAI-MMSCN-CMD) for triggering a state report to the terminals 210, 220, and 230. Such a method is referred to as an event-driven method.

Thereafter, the terminals 210, 220, and 230 transmit state information to the base station 100 (S240, S250, and S260). In this case, the state information includes basic state information.

The base station 100 selects the optimal terminal 210 based on the state information (S270) and requests a mode change to the selected terminal 210 (S280). Thereafter, the terminal 210 changes a mode and is operated in a changed mode (S290).

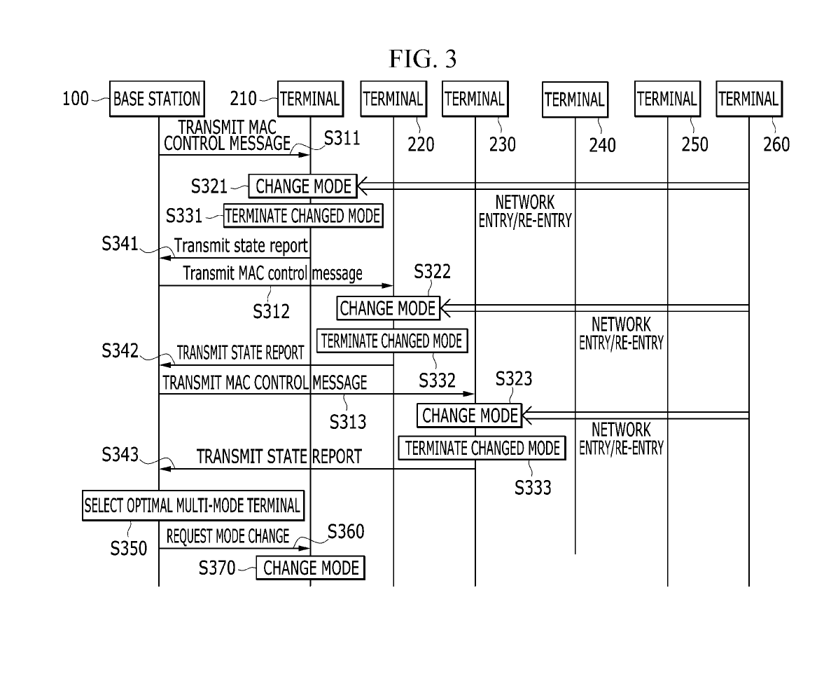

Hereinafter, a communication method according to another exemplary embodiment of the present invention will be described with reference to FIG. 3.

Unlike the cases of FIGS. 1 and 2, FIG. 3 illustrates a case in which the terminals 210, 220, and 230 transmit basic state information and detailed state information to the base station 100, and the detailed state information includes information on terminals that can be connected when the corresponding terminals 210, 220, and 230 perform a function of a base station or a relay station and information that is related to a state of the corresponding terminals 210 220, and 230. Such a method is referred to as an event-driven and polling method.

Referring to FIG. 3, the base station 100 sequentially transmits a MAC control message (AAI-MM-ADV, AAI-HRBS-REQ, AAI-HRRS-REQ, or AAI-MMSCN-CMD) to a plurality of terminals 210, 220, and 230 (S311, S312, and S313). In this case, the base station 100 previously stores a list of a plurality of terminals 210, 220, and 230. Segment information (hereinafter referred to as “base station or relay station temporary activation segment information”), for example, time offset and a basic system configuration parameter that can temporarily activate and operate a base station or relay station function, is included within the AAI-MM-ADV, AAI-HRBS-REQ, AAI-HRRS-REQ, or AAI-MMSCN-CMD message.

The terminals 210, 220, and 230, having received the AAI-MM-ADV, AAI-HRBS-REQ, AAI-HRRS-REQ, or AAI-MMSCN-CMD message, operate in a base station or relay station mode based on base station or relay station temporary activation segment information (S321, S322, and S323). Further, the terminals 210, 220, and 230 scan whether peripheral terminals 240, 250, and 260 attempt network entry or re-entry and handover to the terminals 210, 220, and 230. In this case, network entry or re-entry of the peripheral terminals 240, 250, and 260 is not allowed. The peripheral terminals 240, 250, and 260 include a general terminal that does not operate in a multi-mode.

When a base station or relay station temporary activation segment is terminated, the terminals 210, 220, and 230 terminate the base station or relay station mode (S331, S332, and S333).

Thereafter, the terminals 210, 220, and 230 transmit a state report and scan information to the base station 100 (S341, S342, and S343). That is, the terminals 210, 220, and 230 transmit a state report and scan information to the base station 100 through a newly defined message in an exemplary embodiment of the present invention together with an existing MAC control message and an existing MAC signaling header. In this case, when the terminals 210, 220, and 230 receive the AAI-MM-ADV or AAI-MMSCN-CMD message, the terminals 210, 220, and 230 transmit the AAI-MM-ADV or AAI-MMSCN-CMD message to the base station 100 through an HRMS multimode status report header, which is a MAC signaling header, and an MM-STAT-REP message, and when the terminals 210, 220, and 230 receive the AAI-MM-ADV, AAI-HRRS-REQ, or AAI-HRBS-REQ message, the terminals 210, 220, and 230 transmit the AAI-MM-ADV, AAI-HRRS-REQ, or AAI-HRBS-REQ message to the base station 100 through the AAI-HRBS-RSP or AAI-HRRS-RSP message, which is a MAC control message.

Thereafter, after the base station 100 receives state information from a plurality of terminals 210, 220, and 230 that are included in a list of the base station 100, the base station 100 selects a terminal to operate as a base station or a relay station according to an optimal base station or relay station selection method that is defined in the base station 100 (S350).

The base station 100 transmits the AAI-HRBS-CONFIG-CMD or AAI-HRRS-CONFIG-CMD message, which is a MAC control message, to the selected terminal 210, and requests the terminal 210 to operate in a base station or relay station mode (S360).

Thereafter, the terminal 210 operates as a base station or a relay station (S370).

In this way, according to an exemplary embodiment of the present invention, when the terminal constructs a temporary network by operating as a base station or a relay station, by suggesting a process in which the base station efficiently selects an optimal multi-mode terminal, a service is prevented from being stopped due to a temporary network reconfiguration and reliability of a temporary network can be secured.

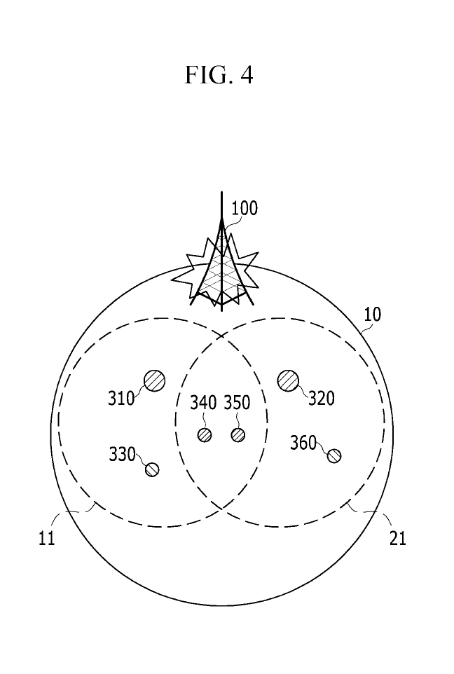

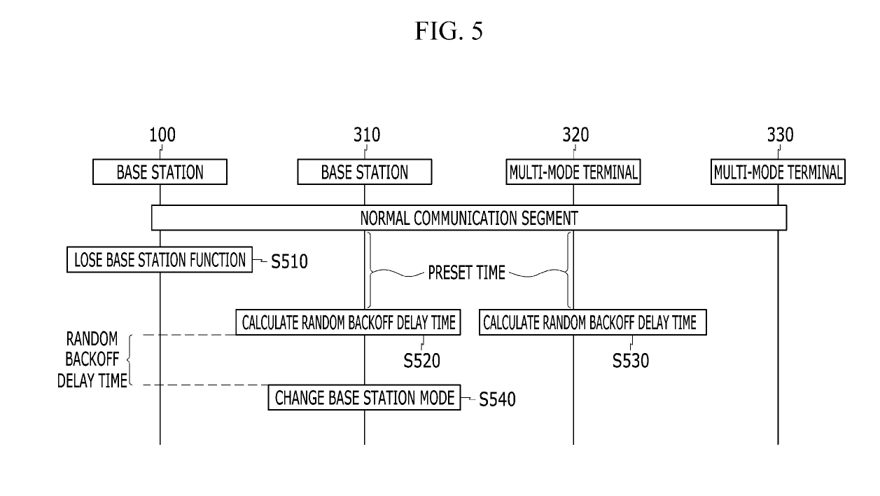

Hereinafter, a method of performing communication of a terminal will be described in detail with reference to FIGS. 4 and 5.

FIG. 4 is a flowchart illustrating an example of electronic wave interference that may occur in a communication system according to an exemplary embodiment of the present invention.

The communication system includes a base station 100, multi-mode terminals 310 and 320, and general terminals 330, 340, 350, and 360. Here, the multi-mode terminals 310 and 320 are terminals that can operate as a base stations or a relay station, and the general terminals 330, 340, 350, and 360 are terminals that operate only as a terminal without operating in a multi-mode.

The multi-mode terminals 310 and 320 and the general terminals 330, 340, 350, and 360 exist in a service area 10 of the base station 100. The multi-mode terminal 310 has a service area 11, the multi-mode terminal 320 has a service area 21, and the service area 11 and the service area 21 are overlapped.

When the base station 100 is damaged without notice, the multi-mode terminals 310 and 320 that have communicated with the base station 100 do not receive an electronic wave signal, for example, a preamble, from the base station 100, and may not receive a signal from another base station or a relay station other than the base station 100. In such an environment, the multi-mode terminals 310 and 320 simultaneously perform a function of a base station while performing a function as a terminal. Thereafter, because the multi-mode terminals 310 and 320 are adjacently disposed, electronic wave interference occurs, and thus the general terminals 330, 340, 350, and 360 cannot perform communication. Further, when the multi-mode terminal 310 performs a function of a base station, if a performance state of the multi-mode terminal 320 is better than that of the multi-mode terminal 310, for example, if a battery residual quantity of the multi-mode terminal 310 is less than that of the multi-mode terminal 320, the multi-mode terminal 310 should transfer a function of a base station to the multi-mode terminal 320. However, when such a transfer operation is performed, a temporal disconnection of the network occurs and thus communication incapability of the general terminals 330, 340, 350, and 360 may occur.

For this purpose, in an exemplary embodiment of the present invention, a method of preventing a plurality of multi-mode terminals from simultaneously performing a base station function and selecting an optimal multi-mode terminal to operate as a base station is suggested. Hereinafter, this will be described in detail with reference to FIG. 5.

FIG. 5 is a flowchart illustrating a communication method according to an exemplary embodiment of the present invention.

Referring to FIG. 5, the multi-mode terminals 310 and 320 and the general terminal 330 existing within the service area 10 of the base station 100 normally communicate with the base station 100 for a normal communication segment. While the multi-mode terminals 310 and 320 and the general terminal 330 normally communicate with the base station 100, as the base station 100 is damaged, the base station may lose a function thereof (S510).

In this case, when the multi-mode terminals 310 and 320 do not receive an electronic wave signal, i.e., a preamble for a preset time from the base station 100, the multi-mode terminals 310 and 320 prepare to perform a base station function. In this case, when the base station 100 has a function thereof break down without notice, the preset time is a time until the multi-mode terminals 310 and 320 determine a conversion attempt of a function thereof to a base station.

Thereafter, the multi-mode terminals 310 and 320 calculate a random backoff delay time using state information thereof (S520 and S530). In this case, the state information of the multi-mode terminal includes deductive state information of the multi-mode terminal such as a battery residual quantity, signal intensity of the base station 100, and a multi-mode ability value of the multi-mode terminals 310 and 320.

If a preamble is received from the base station 100 for waiting by a random backoff delay time, the multi-mode terminals 310 and 320 determine that the base station 100 is recovered, perform a function as a general terminal, and terminate preparation for changing to a base station mode.

If a preamble is not received from the base station 100 while waiting by a random backoff delay time, the multi-mode terminal 310 changes a mode thereof to a base station mode (S540).

Hereinafter, when state information of the multi-mode terminals 310 and 320 is a battery residual quantity, for example, a random backoff delay time will be described.

The random backoff delay time may be counted using a random backoff timer, and is formed with a window such as 0-Wdelay. A random backoff delay time in which the multi-mode terminals 310 and 320 should wait has a random value between 0 and Wdelay. In this case, a Wdelay value may be determined in consideration of a battery residual quantity. That is, when a battery residual quantity increases, the Wdelay value decreases, and when a battery residual quantity decreases, the Wdelay value increases.

In this way, after the random backoff timer has expired, the multi-mode terminals 310 and 320 determine whether to change a base station mode, thereby preventing a plurality of multi-mode terminals 310 and 320 from simultaneously performing a base station function. Further, when calculating a random backoff delay time, the random backoff delay time is determined in consideration of state information of the multi-mode terminals 310 and 320, and thus an optimal multi-mode terminal can perform a function of a base station.

According to a conventional art, when the base station 100 loses a function without notice, as a plurality of multi-mode terminals 310 and 320 simultaneously start a base station function, electronic wave interference may excessively occur, but according to an exemplary embodiment of the present invention, when the multi-mode terminals 310 and 320 do not receive a preamble from the base station 100 for a random backoff delay time, the multi-mode terminals 310 and 320 start a function of a base station, thereby preventing electronic wave interference.

Further, according to an exemplary embodiment of the present invention, when calculating a random backoff delay time, by determining the multi-mode terminals 310 and 320 to perform a function of a base station in consideration of state information such as a battery residual quantity of the multi-mode terminals 310 and 320, the optimal multi-mode terminals 310 and 320 perform a function of a base station. Thereby, temporal network disconnection and load due to transfer of a base station function between the multi-mode terminals 310 and 320 can be minimized. According to the present invention, a method and procedure for forming optimal temporary network topology by a multi-mode terminal can be provided.

Further, according to the present invention, when multi-mode terminals perform a function of a base station, a method of selecting a multi-mode terminal that can avoid mutual electronic wave interference and that can perform an optimal base station function is suggested, and thus reliability of a communication network can be secured.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method of performing communication of a terminal, the method comprising:
the terminal starting a mode change when a base station is damaged, if a random backoff timer has expired; and
the terminal operating as a base station after the mode change is complete.

2. The method of claim 1, wherein a random backoff delay time that is calculated by the random backoff timer is determined according to state information of the terminal.

3. The method of claim 2, wherein the state information comprises a battery level of the terminal.

4. The method of claim 1, wherein the terminal is a multi-mode terminal that can operate as a base station or a relay station.
